(19) United States
(12) Patent Application Publication
(10) Pub. No.: US 2017/0148034 A1
(43) Pub. Date: May 25, 2017

(54) SPEND ENGAGEMENT RELEVANCE TOOLS

(71) Applicant: American Express Travel Related Services Company, Inc., New York, NY (US)

(72) Inventors: Ashish Kapatia Sharma, Jersey City, NJ (US); Sangarsh Nigam, New Providence, NJ (US); Arnab Bose, Jersey City, NJ (US); Mira Srinivasan, Jersey City, NJ (US); Faisal Ahmad, Jersey City, NJ (US)

(73) Assignee: American Express Travel Related Services Company, Inc., New York, NY (US)

(21) Appl. No.: 14/949,001

(22) Filed: Nov. 23, 2015

(51) Int. Cl. G06Q 30/02

(52) U.S. Cl. CPC G06Q 30/0201

(57) ABSTRACT

Systems and methods of improving the operation of a transaction network and transaction network devices is disclosed. A spend engagement and relevance diagnostics host may comprise various modules and engines wherein a merchant and/or customer transaction record may be evaluated for establishing proper usage of differentiated transaction instruments according to their proper purposes, proper acceptance by merchants of differentiated transaction instruments, and delivery of value-added data such as electronically indicated offers. A relevant merchant/customer industry identifier may determine a relevant merchant to at least one known customer, whereby the transaction network may tailor the handling of the transaction, such as by identifying by a benchmark competitor/merchant identifier at least one of a benchmark competitive customer and merchant, whereby the transaction network may actively deliver value-added data in response to the identifying steps, whereby the transaction network more properly functions according to approved parameters.

### FIELD

The present disclosure relates to data analytics for transaction data.

### BACKGROUND

Large data sets may exist in various sizes and with various levels of organization. With big data comprising data sets as large as ever, the volume of data collected incident to the increased popularity of online and electronic transactions continues to grow. Billions of rows and hundreds of thousands of columns worth of data may populate a single table, for example. An example of the use of big data is in identifying and categorizing business spending and consumer spending, which is frequently a key priority for transaction card issuers. In that regard, transactions processed by the transaction card issuer are massive in volume and comprise tremendously large data sets.

Large data sets may have challenges. For example, cardholders may frequently hold a business-oriented transaction card, but various merchants may or may not accept the business-oriented transaction card. Moreover, metric occultation and data asymmetry may frustrate and impede the identification and categorization of transactions, transaction counter parties, and potential value-adding interactions, while hampering data analytics.

### SUMMARY

In accordance with various embodiments, A spend engagement and relevance diagnostics host is disclosed. The spend engagement and relevance diagnostics host may include a processor and a tangible, non-transitory memory configured to communicate with the processor, the tangible, non-transitory memory having instructions stored thereon that, in response to execution by the processor, cause the processor to perform operations. The spend engagement and relevance diagnostics host may include a relevant merchant/customer industry identifier in communication with the processor and configured to determine a merchant or a merchant industry relevant to a known customer industry of a known customer. The spend engagement and relevance diagnostics host may include a benchmark competitor/merchant identifier in communication with the processor and configured to identify a benchmark competitive customer of the known customer industry. The spend engagement and relevance diagnostics host may include a referral generator in communication with the processor and configured to prepare a first referral comprising a reference of the at least one of a merchant or a merchant industry to the known customer in response to the benchmark competitor/merchant identifier. The spend engagement and relevance diagnostics host may include a referral delivery interface in communication with the processor and configured to deliver the first referral to an electronic network. The spend engagement and relevance diagnostics host may include a communication bus disposed in logical communication with the relevant merchant/customer industry identifier, the referral generator, the benchmark competitor/merchant identifier, and the referral delivery interface. The spend engagement and relevance diagnostics host may include a bus controller disposed in logical communication with the communication bus and configured to direct communication among the relevant merchant/customer industry identifier, the referral generator, the benchmark competitor/merchant identifier, and the referral delivery interface.

In various embodiments, the relevant merchant/customer industry identifier may include an engagement assessment engine configured to at least one of identify engaged customers, a spend purpose identification module in logical communication with the engagement assessment engine and configured to identify business spending of the engaged customers, a merchant industry ranker in logical communication with the spend purpose identification module and configured to order a plurality of merchant industries of merchants associated with the business spending into a rank order in response to a four variable index, and a noise filter in logical communication with the merchant industry ranker and configured to cull the engaged customers wherein the rank order is determined, and wherein the noise filter is configured to cull in response to a similarity score.

In various embodiments, the engaged customer includes a customer who at least one of spends greater than a first threshold amount, for example, $100,000 annually via a transaction instrument, wherein a quotient of spending over revenue of the customer is greater than a first threshold percent, for example, ten percent.

In various embodiments, the four variable index includes a first variable including a number of customers from a chosen customer industry transacting in a merchant industry, a second variable including a number of customers who have this merchant industry as one of their top ten industries by at least one of volume and expenditure, a third variable including a percentage of customers who have this merchant industry as one of their top ten industries by at least one of volume and expenditure, and a fourth variable including a rank of customer industry that is transacting in the merchant industry among all customer industries transacting in the merchant industry.

In various embodiments, the noise filter includes a similarity score definer configured to define a base similarity score, a math engine configured to calculate a similarity score of each of the engaged customers according to a similarity calculation, a cull module configured to cull each of the engaged customers having the similarity score less than the base similarity score, and a noise filter bus controlled by an iteration controller and interconnecting the similarity score definer, the math engine, and the cull module in logical communication.

In various embodiments, the similarity calculation includes

$$Similarity = 1 - \frac{\sum {amount}_{i} \times {rank}_{i}}{\sum {amount}_{i}} / max ( {rank}_{i} ) .$$

In various embodiments, the benchmark competitor/merchant identifier includes a competitor aggregator configured to aggregate a plurality of competitive entities, an engagement evaluator configured to identify a customer that at least one of spends greater than a second threshold amount, for example, greater than $15,000 in an industry and that spends at least a first income percentage, for example, 10% of an income of the customer in the industry, and a relevancy module configured to ascertain a relevancy of the engaged competitive entities.

In various embodiments, the relevancy of the engaged competitive entities may be a geographic proximity and/or an industry code.

In various embodiments, the referral generator includes a competitor selector configured to determine a competitor list of the customer, a merchant identifier configured to identify a merchant list of merchants transacting with the competitor list, and a relevancy module configured to order the merchant list according to a relevancy factor set.

The relevancy factor set may include a willingness to accept a transaction instrument, a transaction size, and a number of customers.

The spend engagement and relevance diagnostics host may further include a limited penetration merchant industry determiner configured to receive a referral information from the referral generator and determine a limited penetration merchant industry including a merchant industry wherein fewer than a transaction count floor of transactions are completed, and a bonus incentivizing engine configured to transmit at least one offer to at least one customer for a transaction within the limited penetration merchant industry.

In various embodiments, the offer includes at least one of a discount, an advertisement, and rebate.

A spend engagement and relevance diagnostics network is disclosed. The network may include a spend engagement and relevance diagnostics host configured to deliver value added data comprising electronically indicated offers, wherein the spend engagement and relevance diagnostics host directs data to be stored. The network may include a distributed storage system having a plurality of nodes, the distributed storage system configured to direct data to the spend engagement and relevance diagnostics host. The network may include a telecommunications transfer channel including a network logically connecting the spend engagement and relevance diagnostics host to the distributed storage system.

A method of spend engagement and relevance diagnostics is disclosed. The method may include determining, by a relevant merchant/customer industry identifier in communication with a processor, a merchant industry relevant to a known customer industry of a known customer, identifying, by a benchmark competitor/merchant identifier in communication with the processor, a benchmark competitive customer of the known customer industry, preparing, by a referral generator in communication with the processor, a first referral comprising a reference of the at least one of a merchant or the merchant industry to the known customer in response to the identifying, and delivering, by a referral delivery interface in communication with the processor, the first referral to an electronic network.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary system for distributed storage and distributed processing, in accordance with various embodiments;

FIG. 2 illustrates an exemplary spend engagement and relevance diagnostics host component of a system according to FIG. 1, in accordance with various embodiments;

FIG. 3 illustrates an exemplary relevant industry identifier of a spend engagement and relevance diagnostics host of FIG. 2, in accordance with various embodiments;

FIG. 4 illustrates an exemplary noise filter of a relevant industry identifier of FIG. 3, in accordance with various embodiments;

FIG. 5 illustrates a benchmark competitor identifier of a spend engagement and relevance diagnostics host of FIG. 2, in accordance with various embodiments; and

FIG. 6 illustrates a referral generator of a spend engagement and relevance diagnostics host of FIG. 2, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

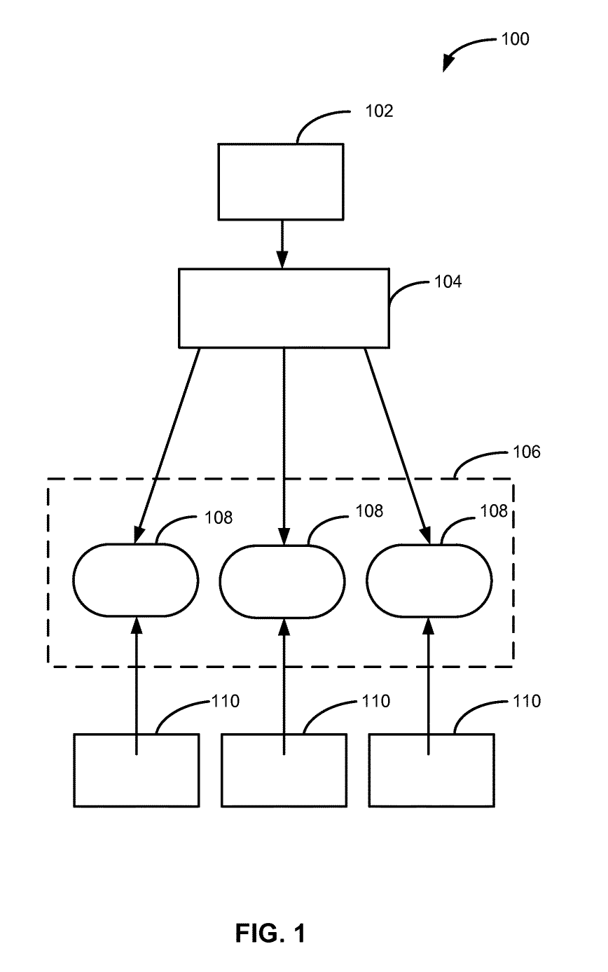

With reference to FIG. 1, system 100 for distributed data storage and processing is shown, in accordance with various embodiments. System 100 may comprise a spend engagement and relevance diagnostics host 102. Spend engagement and relevance diagnostics host 102 may comprise any device capable of receiving and/or processing an electronic message via telecommunications transfer channel 104. Telecommunications transfer channel 104 may comprise a network. Spend engagement and relevance diagnostics host 102 may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over telecommunications transfer channel 104.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

As used herein, the term “bus” may mean a physical bus, such as a physical data bus, or may mean a logical bus, such as a logical data bus whereby a communication channel among certain disclosed aspects is provided.

In various embodiments, spend engagement and relevance diagnostics host 102 may interact with distributed storage system 106 for storage and/or processing of big data sets. As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, from merchant databases, from customer databases, or from other suitable sources. Big data sets may be compiled without descriptive metadata such as column types, counts, percentiles, or other interpretive-aid data points.

In various embodiments, distributed storage system 106 may comprise one or more nodes 108. Nodes 108 may comprise computers or processors the same as or similar to spend engagement and relevance diagnostics host 102. Nodes 108 may be distributed geographically in different locations, housed in the same building, and/or housed in the same rack. Nodes 108 may also be configured to function in concert to provide storage space and/or processing power greater than one of a node 108 might provide alone. As a result, distributed storage system 106 may collect and/or store the data 110. Data 110 may be collected by nodes 108 individually and compiled or in concert and collated. Data 110 may further be compiled into a data set and formatted for use by spend engagement and relevance diagnostics host 102.

In various embodiments, data 110 may comprise a collection of data including and/or originating from cardholder information, transaction information, account information, record of sales, account history, customer history, sensor data, machine log data, data storage system, public web data, and/or social media. Data 110 may be collected from multiple sources and amalgamated into a big data structure such as a file, for example. In that regard, the data may be used as an input to generate metadata describing the big data structure itself, as well as the data stored in the structure.

The distributed storage system 106 may comprise a transaction network. A spend engagement and relevance diagnostics host 102 may comprise various modules and engines as discussed herein wherein merchant and/or customer (e.g., card holder or card member) transaction records are evaluated for establishing proper usage of differentiated transaction instruments according to their proper purposes, proper acceptance by merchants of differentiated transaction instruments, and for delivery of value-added data such as electronically indicated offers, currency substitutes (such as discounts) and/or the like. For instance, a transaction may be identified as being associated with a particular merchant, customer, customer industry, merchant industry, and/or the like, wherein the transaction network may tailor the handling of the transaction. For example, by denying it, by suggesting value-added data, by indicating a merchant mishandling of the transaction (such as merchant denial of a transaction product), and/or the like. The transaction network may actively deter misuse of transaction products and actively encourage desired uses of transaction products, wherein the transaction network more properly functions according to approved parameters.

Merchant acceptance for large dollar business-to-business transactions is far from ubiquitous. For example, various categories of transaction mechanisms may be presented. For instance, a card type may be selected from among various preprogrammed card type categories such as a category one, category two, or category three card. In various embodiments, a category one card may comprise a consumer-oriented card (e.g., a “consumer card”), a category two card may comprise a small-business oriented card (e.g., an “SBO card”), and a category three card may comprise a large business-oriented card (e.g., an “enterprise card”).

Consumers may desire to utilize various cards, such as a category two or category three card for business to business transactions; however, a merchant may be disinclined to accept such a card. As such, a spend engagement and relevance diagnostics platform is proposed with a data analytics mechanism whereby an industry of each cardholder may be identified, relevant merchants relevant to members of identified industries may be determined, competitors of each card holder may be identified, the relevant merchants of the competitors may be similarly identified, and complex diagnostic processes may be activated, whereby recommendations of merchants may be made to consumers based on machine processes. In various embodiments, relevant means having desired characteristics such as a certain amount of spending, volume of transactions, type of goods, and/or the like.

Moreover, in response to the evaluation of merchants, customers, and competitors of each, merchants suppressing usage of particular transaction instruments may be identified and such suppression may be unplugged.

Furthermore, various further analytic outcomes may accomplished, for instance, identification of transactions having a business purpose, identification of relevant competitors of each card holder and each merchant, prediction of card holder purchasing needs in view of card holder industry and relative position therein.

Furthermore, aggregate factors may be implemented to ascertain relevant merchant industry/customer relationships such as a number of customers from a card member's industry transacting at a particular merchant, the number of customers from a card member's industry having a given merchant and/or a given merchants industry as a top-ten aggregate spending targets, a percentage of customers indicating a given merchants industry as a top-ten aggregate spending target, the importance of the card member's industry for a given merchant's industry (as indicated by relative expenditure ranking).

Moreover, aggregate factors may be implemented to ascertain, by ranking, relevant competitor identification of relevant competitors of a card holder, such as card member industry, gross sales, nearest geographic location, greatest spend engagement with card provider.

Still further, relevant business-to-business merchants may thus be determined, such as by leveraging a logistic regression model whereby merchants are ranked and ordered. Such recommendations may be delivered by mechanisms including Hadoop platforms, Salesforce mechanisms, and mobile user devices. Variables may be ingested by a sort determiner which provides a sorting of relevant customers/customer industries for a merchant/merchant industry. Variables may similarly provide a sorting of relevant merchants/merchant industries for a customer/customer industry, whereby desired uses of transaction products may be encouraged by blocking transactions, presenting electronic offers for alternative transaction instruments, and/or providing incentives/discounts to improve the functioning of the transaction network to which the merchants and customers have access.

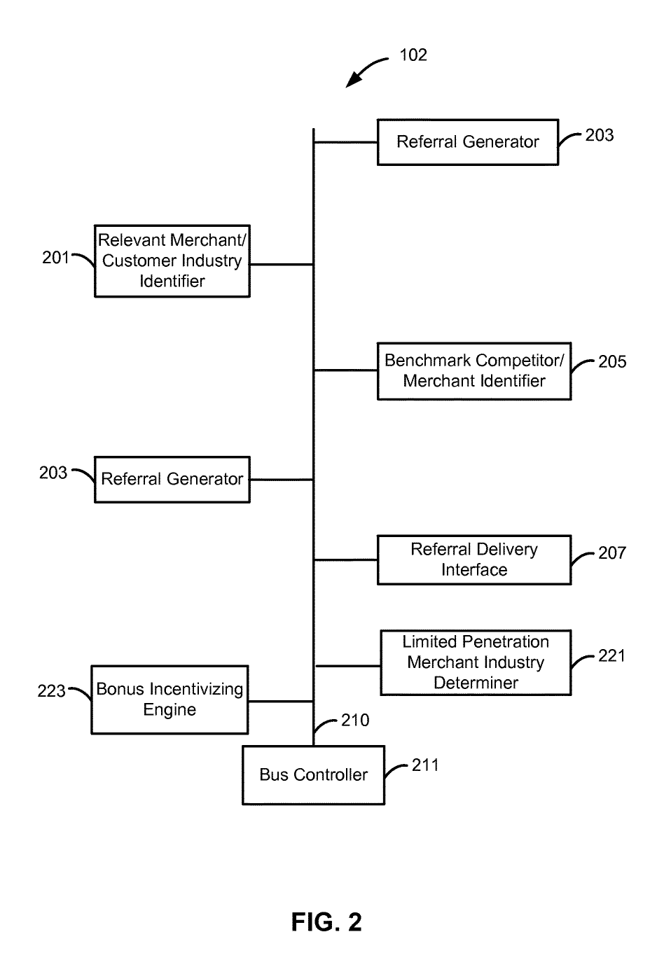

With reference to FIG. 1 and FIG. 2, in various embodiments, a spend engagement and relevance diagnostics host 102 is described in more particular detail. For instance, a spend engagement and relevance diagnostics host 102 may comprise various logical modules configured to perform various operations and processes in accordance with methods disclosed herein. A spend engagement and relevance diagnostics host 102 may include a relevant merchant/customer industry identifier 201. The relevant merchant/customer industry identifier 201 may interoperate with a referral generator 203, a benchmark competitor/merchant identifier 205, and a referral delivery interface 207. Each such module may interoperate via a communication bus 210 by transceiving messages and data, and may perform various calculations, decisions, and operations in accordance with the teachings herein. Moreover, spend engagement and relevance diagnostics host 102 may further comprise a bus controller 211 configured to manage communications among modules on the communication bus 210, and direct various modules to perform various operations and processes in accordance with methods disclosed herein, as well as direct communications with external components such as distributed storage system 106, nodes 108, and/or the like. In various embodiments, bus controller may direct the modules to perform feedback communication, feedback decisions, and feedback operations, such as to promote further refinement of outputs by feeding them back as at least a component of an input, and/or machine learning as desired. For instance, in various embodiments, a similarity score calculation may be iteratively improved by elimination of noise, as discussed herein. A spend engagement and relevance diagnostics host 102 may include a relevant merchant/customer industry identifier 201, as mentioned. The relevant merchant/customer industry identifier 201 may interoperate with a limited penetration merchant industry determiner 221 and a bonus incentivizing engine 223. Each such module may interoperate via a communication bus 210 by transceiving messages and data, and may perform various calculations, decisions, and operations in accordance with the teachings herein.

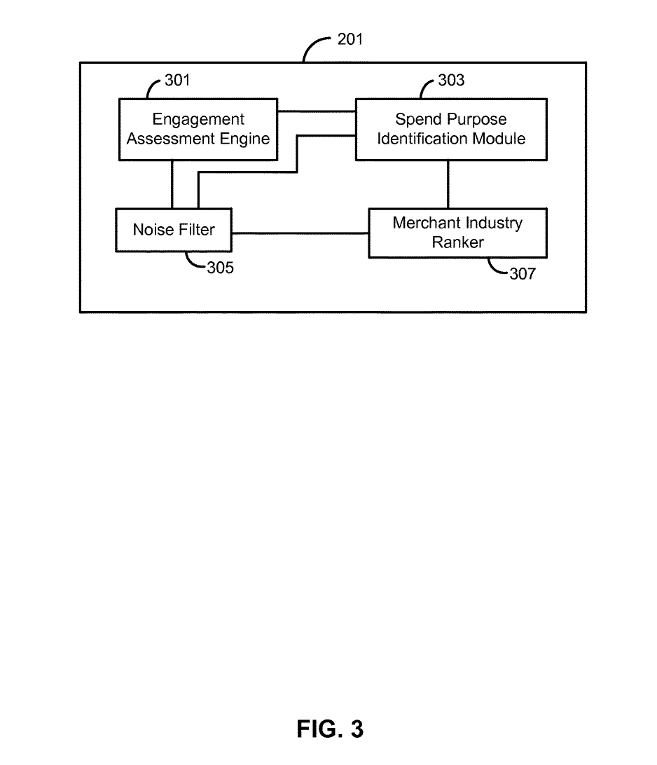

With reference to FIGS. 1, 2, and 3, a relevant merchant/customer industry identifier 201 is discussed in further detail. For instance, a relevant merchant/customer industry identifier 201 may be configured to determine a merchant or merchant industry that is relevant to a given customer or customer industry. For instance, to determine a merchant industry's relevance, the relevant merchant/customer industry identifier 201 may determine a number of customer industries that spend at this merchant industry divided by a total number of customer industries to determine the relative relevance of that merchant industry. Similarly, a relevant merchant/customer industry identifier 201 may be configured to determine a customer or customer industry that is relevant to a given merchant or merchant industry. For instance, and with reference to FIG. 3, a relevant merchant/customer industry identifier 201 may have various logical modules. For instance, an engagement assessment engine 301 may be in logical communication with a spend purpose identification module 303 and a noise filter 305. Similarly, the spend purpose identification module 303 may be in logical communication with a merchant industry ranker 307 and the noise filter 305. The various modules may operate as follows. Furthermore, the merchant industry ranker 307 may similarly be in logical communication with the noise filter 305.

An engagement assessment engine 301 may be configured to identify engaged customers and/or alternately, to identify engaged merchants. For example, the engagement assessment engine 301 may identify a customer that may be said to be “deeply engaged” with a card issuer. For instance, a deeply engaged customer may comprise a customer who spends greater than a first threshold amount, for example, $100,000 annually via a transaction account of the card issuer, a customer for whom the quotient of the customer's spending over the customer's revenue is greater than a first threshold percent, for example, ten percent, a customer having relatively higher penetration, as discussed herein in a relatively relevance-weighted merchant industry.

A spend purpose identification module 303 may be configured to identify the business needs of the engaged customers identified by the engagement assessment engine 301. In other words, the spend purpose identification module 303 may be configured to identify business need spending by the engaged customers. As such, various variables may be considered to determine business need, for example, by calculating the magnitude of business spending in dollars per year.

A merchant industry ranker 307 may be configured to order the merchant industries of the merchants associated with the spending by the engaged customers according to a merchant industry index. The merchant industry index may comprise an index based on variables. For instance, a merchant industry index may comprise an index based on four variables. For example, a first variable comprising a number of customers from the chosen customer industry that is transacting in a merchant industry, a second variable comprising the number of customers who have this merchant industry as one of their top ten industries, a third variable comprising a percentage of customers who have this merchant industry as one of their top ten industries, and a fourth variable comprising the rank of customer industry that is transacting in the merchant industry among all customer industries transacting in a merchant industry. As such, a rank order may be defined in response to the four variables. Each variable may be calculated for each merchant industry of the merchants associated with the spending by the engaged customers. Each such industry may be ranked in order of magnitude with respect to each variable (e.g., from most to least number of customers from a chosen customer industry that is transacting in a merchant industry for the first variable). Then, the ranks of each merchant industry across the four variables may be summed. The merchant industries may then be organized by this rank from smallest to greatest numerical rank, into a rank order.

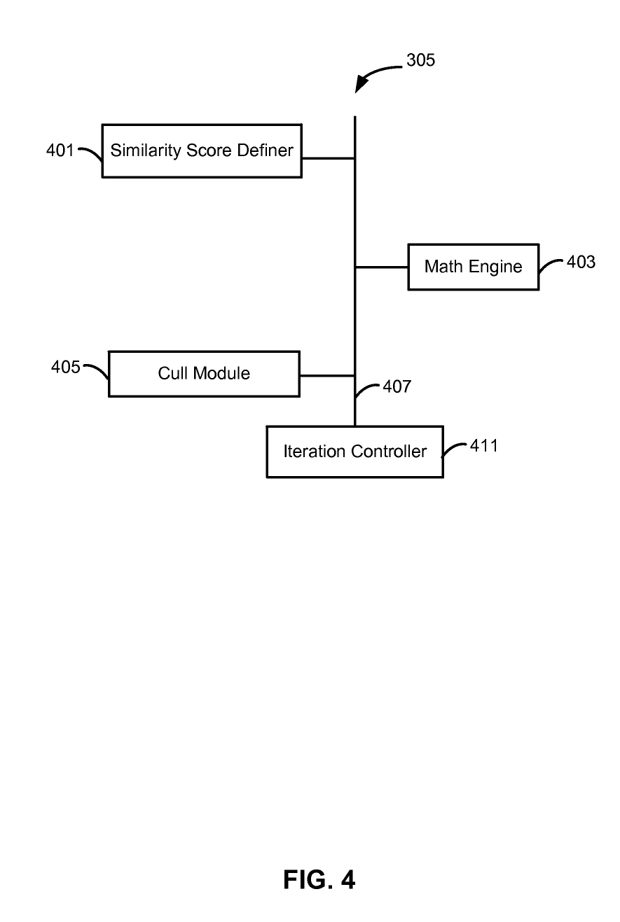

A noise filter 305 may further process the rank order provided by the merchant industry ranker 307, such as to eliminate (“cull”) erroneous, extraneous, or otherwise anomalous data as elaborated below. For instance, with reference to FIG. 4, a noise filter 305 may comprise various sub-components, such as a similarity score definer 401, a math engine 403, a cull module 405 all interconnected on a noise filter bus 407 and controlled by an iteration controller 411 in communication with the noise filter bus 407. The similarity score definer 401 may be configured to define a base similarity score to identify noisy customers. The math engine 403 may perform calculations such as to determine a similarity score. For instance, one such similarity calculation may comprise:

$$Similarity = 1 - \frac{\sum {amount}_{i} \times {rank}_{i}}{\sum {amount}_{i}} / max ( {rank}_{i} )$$

Moreover, the cull module 405 may subsequently remove a portion of the customers having the least similarity score, for instance, the lower twenty percent of customers. Finally, the iteration controller 411 may direct the cull module 405 to intercommunicate with the similarity score definer 401 to iterate the process, until a desired amount of dissimilar customers are removed, whereby the rank order may be refined and/or improved due to the dis-inclusion of customers who are erroneous, extraneous, or otherwise anomalous, such as a result of being sufficiently dissimilar from other customers.

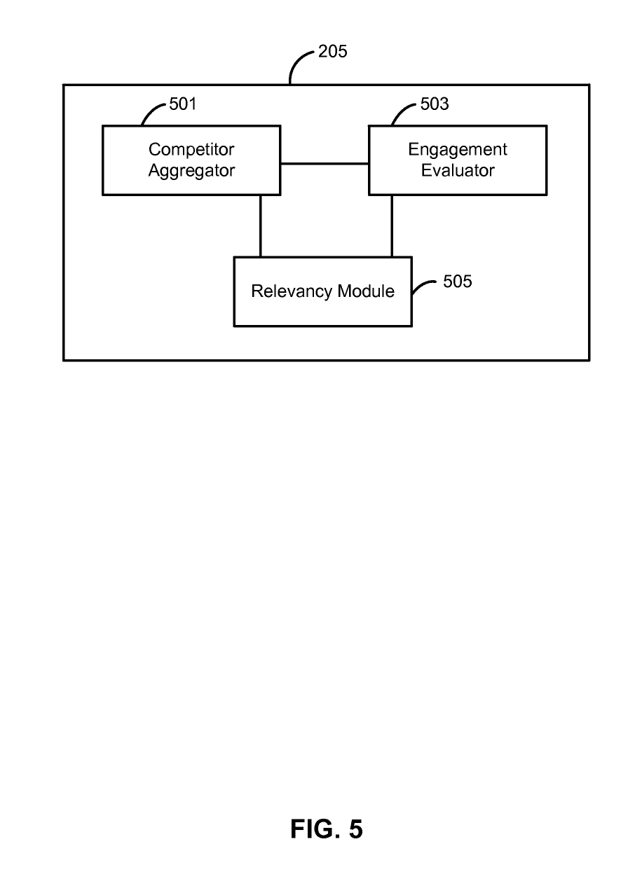

Having discussed various aspects of the relevant merchant/customer industry identifier 201, attention is directed at FIGS. 1, 2, and 5 wherein the benchmark competitor/merchant identifier 205 of the spend engagement and relevance diagnostics host 102 is detailed. A benchmark competitor/merchant identifier 205 may comprise a competitor aggregator 501, an engagement evaluator 503, and a relevancy module 505. These modules may interoperate to identify a benchmark competitive customer for customers, and/or a benchmark competitive merchant for merchants. For instance, in various embodiments, the competitor aggregator 501 may aggregate all other competitive entities (such as merchants or customers). For instance, the competitor aggregator 501 may identify similar customers, such as those in the same industry and with similar revenue. The engagement evaluator 503 may implement mechanisms discussed herein to ascertain the relative engagement of the various individual competitive entities that have been compiled in aggregate. The engagement evaluator 503 may be configured to identify engaged customers and/or engaged merchants. For example, the engagement evaluator 503 may identify a customer that may spend greater than $15,000 in an industry, and/or who spends at least 10% of that customers total spending within an industry. The relevancy module 505 may ascertain the relevancy of the engaged competitive entities to the entity as issue. For example, the relevancy module 505 may assess geographic proximity, an industry code (e.g., standard industry code or SIC code), or other factors. As such, the relevant merchant/customer industry identifier 201 may identify the industry in which a merchant and/or customer resides by assessing the relevancy of potentially competitive entities that are shown to be “engaged” and then adopting the industry thereof. This adoption of the industry thereof effectuates an identification of the industry of the instant entity. Thus, a first referral may be delivered to a referral delivery interface 207 and the first referral may be chosen with regard to the adopted industry.

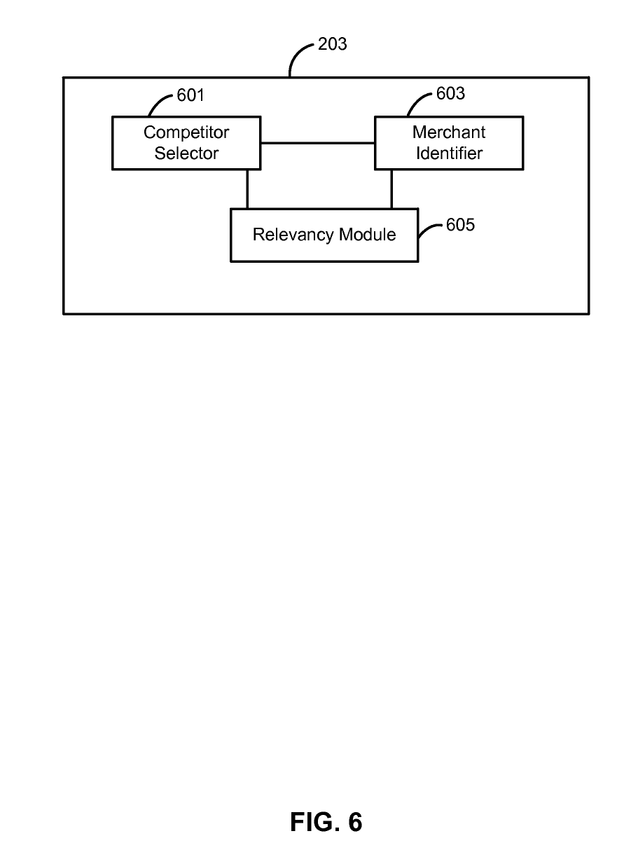

A spend engagement and relevance diagnostics host 102 may further include a referral generator 203. A referral generator 203 may include a mechanism whereby customers may be referred to merchants (e.g., a first referral may be delivered to a referral delivery interface 207 configured to deliver the first referral to an electronic network). For instance, with reference to FIGS. 1, 2, and 6, a referral generator 203 may include a competitor selector 601, a merchant identifier 603, and a relevancy module 605. The competitor selector 601 may at least one of permit a customer to identify their own competitors and/or a list of competitors (competitor list) may be pre-chosen based on relevance index. A merchant identifier 603 may operate to identify only those merchants where the identified competitors do business. Finally, the relevancy module 605 may order those merchants where the identified competitors do business by their relevance (e.g., according to a relevancy factor set). For instance, the merchants may be ordered responsive to a relevancy factor set comprising their willingness to accept a transaction instrument, transaction size, number of customers, and/or the like. For instance, a willingness quotient comprising a number of transactions effectuated with a given transaction instrument divided by total transactions at the merchant may be computed, or transaction size may be measured, or number of customers counted and/or the like.

With reference now to FIGS. 1, and 2, a spend engagement and relevance diagnostics host 102 may comprise a limited penetration merchant industry determiner 221 and a bonus incentivizing engine 223, as previously mentioned. A limited penetration merchant industry determiner may receive the referral information from a referral generator 203. The bonus incentivizing engine 223 may transmit offers, such as discounts, advertisements, and/or the like to those customers identified to be referred to merchants by the referral generator 203. In further embodiments, a bonus incentivizing engine 223 may interoperate with the limited penetration merchant industry determiner 221. For instance, the limited penetration merchant industry determiner 221 may identify merchant industries with limited penetration (e.g., fewer than a transaction count floor of transactions are completed on a specified transaction instrument in this industry). In response, the bonus incentivizing engine 223 may create bonus incentives on the specified transaction instrument for transactions in this industry, for example, discounts, rebates, cash back, and/or zero interest lending.

Data, as discussed herein, may include “internal data.” Internal data may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A spend engagement and relevance diagnostics host comprising:
a processor,
a tangible, non-transitory memory configured to communicate with the processor, the tangible, non-transitory memory having instructions stored thereon that, in response to execution by the processor, cause the processor to perform operations;
a relevant merchant/customer industry identifier in communication with the processor and configured to determine a merchant or a merchant industry relevant to a known customer industry of a known customer;
a benchmark competitor/merchant identifier in communication with the processor and configured to identify a benchmark competitive customer of the known customer industry;
a referral generator in communication with the processor and configured to prepare a first referral comprising a reference of the at least one of a merchant or a merchant industry to the known customer in response to the benchmark competitor/merchant identifier;
a referral delivery interface in communication with the processor and configured to deliver the first referral to an electronic network;
a communication bus disposed in logical communication with the relevant merchant/customer industry identifier, the referral generator, the benchmark competitor/merchant identifier, and the referral delivery interface; and
a bus controller disposed in logical communication with the communication bus and configured to direct communication among the relevant merchant/customer industry identifier, the referral generator, the benchmark competitor/merchant identifier, and the referral delivery interface.

2. The spend engagement and relevance diagnostics host of claim 1, wherein the relevant merchant/customer industry identifier comprises:
an engagement assessment engine configured to identify an engaged customers;
a spend purpose identification module in logical communication with the engagement assessment engine and configured to identify business spending of the engaged customers;
a merchant industry ranker in logical communication with the spend purpose identification module and configured to order a plurality of merchant industries of merchants associated with the business spending into a rank order in response to a four variable index; and
a noise filter in logical communication with the merchant industry ranker and configured to cull the engaged customers whereby the rank order is determined, and
wherein the noise filter is configured to cull in response to a similarity score.

3. The spend engagement and relevance diagnostics host of claim 2, wherein the engaged customers at least one of spend greater than a first threshold amount via a transaction instrument, and exhibit a quotient of spending over revenue greater than a first threshold percent.

4. The spend engagement and relevance diagnostics host of claim 2, wherein the four variable index comprises:
a first variable comprising a number of the engaged customers from a customer industry transacting in the merchant industry;
a second variable comprising a number of the engaged customers who have the merchant industry as one of their top ten industries by at least one of volume and expenditure;
a third variable comprising a percentage of the engaged customers who have the merchant industry as one of their top ten industries by at least one of volume and expenditure; and
a fourth variable comprising a rank of customer industry that is transacting in the merchant industry among all customer industries transacting in the merchant industry.

5. The spend engagement and relevance diagnostics host of claim 2, wherein the noise filter comprises:
a math engine configured to calculate the similarity score of each of the engaged customers according to a similarity calculation;
a similarity score definer configured to define a base similarity score;
a cull module configured to cull each of the engaged customers having the similarity score less than the base similarity score; and
a noise filter bus controlled by an iteration controller and interconnecting the similarity score definer, the math engine, and the cull module in logical communication.

6. The spend engagement and relevance diagnostics host of claim 5, wherein the similarity calculation comprises:
$$Similarity = 1 - \frac{\sum {amount}_{i} \times {rank}_{i}}{\sum {amount}_{i}} / max ( {rank}_{i} ) .$$

7. The spend engagement and relevance diagnostics host of claim 2, wherein the benchmark competitor/merchant identifier comprises:
a competitor aggregator configured to aggregate a plurality of competitive entities;
an engagement evaluator configured to identify the engaged customer that at least one of spends greater than a second threshold amount in an industry and that spends at least a first income percentage of an income of the engaged customer in the industry.

8. The spend engagement and relevance diagnostics host of claim 7, wherein a relevancy of the engaged customer comprises at least one of a geographic proximity or an industry code.

9. The spend engagement and relevance diagnostics host of claim 2, wherein the referral generator comprises:
a competitor selector configured to determine a competitor list of the engaged customer;
a merchant identifier configured to identify a merchant list of merchants transacting with the competitor list; and
a relevancy module configured to order the merchant list according to a relevancy factor set.

10. The spend engagement and relevance diagnostics host of claim 9, wherein the relevancy factor set comprises a willingness to accept a transaction instrument, a transaction size, and a number of customers.

11. The spend engagement and relevance diagnostics host of claim 1, further comprising:
a limited penetration merchant industry determiner configured to receive a referral information from the referral generator and determine a limited penetration merchant industry comprising a merchant industry wherein fewer than a transaction count floor of transactions are completed; and
a bonus incentivizing engine configured to transmit at least one offer to at least one customer for a transaction within the limited penetration merchant industry.

12. The spend engagement and relevance diagnostic host of claim 11, wherein the offer comprises at least one of a discount, an advertisement, and rebate.

13. A spend engagement and relevance diagnostics network comprising:
a spend engagement and relevance diagnostics host configured to deliver value added data comprising electronically indicated offers;
wherein the spend engagement and relevance diagnostics host directs data to be stored,
a distributed storage system comprising a plurality of nodes,
the distributed storage system configured to direct data to the spend engagement and relevance diagnostics host; and
a telecommunications transfer channel comprising a network logically connecting the spend engagement and relevance diagnostics host to the distributed storage system.

14. The spend engagement and relevance diagnostics network of claim 13, wherein the spend engagement and relevance diagnostics host comprises:
a processor,
a tangible, non-transitory memory configured to communicate with the processor, the tangible, non-transitory memory having instructions stored thereon that, in response to execution by the processor, cause the processor to perform operations;
a relevant merchant/customer industry identifier in communication with the processor and configured to determine a merchant industry relevant to a known customer industry of a known customer;
a benchmark competitor/merchant identifier in communication with the processor and configured to identify a benchmark competitive customer within the known customer industry;
a referral generator in communication with the processor and configured to prepare a first referral comprising a reference of the merchant or the merchant industry to the known customer in response to the benchmark competitor/merchant identifier;
a referral delivery interface in communication with the processor and configured to deliver the first referral to an electronic network;
a communication bus disposed in logical communication with the relevant merchant/customer industry identifier, the referral generator, the benchmark competitor/merchant identifier, and the referral delivery interface; and
a bus controller disposed in logical communication with the communication bus and configured to direct communication among the relevant merchant/customer industry identifier, the referral generator, the benchmark competitor/merchant identifier, and the referral delivery interface.

15. The spend engagement and relevance diagnostics network of claim 14, wherein the relevant merchant/customer industry identifier comprises:
an engagement assessment engine configured to identify an engaged customers;
a spend purpose identification module in logical communication with the engagement assessment engine and configured to identify business spending of the engaged customers;
a merchant industry ranker in logical communication with the spend purpose identification module and configured to order a plurality of merchant industries of merchants associated with the business spending into a rank order in response to a four variable index; and
a noise filter in logical communication with the merchant industry ranker and configured to cull the engaged customers whereby the rank order is determined, and
wherein the noise filter is configured to cull in response to a similarity score.

16. The spend engagement and relevance diagnostics host of claim 15, wherein the engaged customers at least one of spend greater than a first threshold amount via a transaction instrument, and exhibit a quotient of spending over revenue greater than a first threshold percent.

17. The spend engagement and relevance diagnostics host of claim 15, wherein the four variable index comprises:
a first variable comprising a number of the engaged customers from a customer industry transacting in the merchant industry;
a second variable comprising a number of the engaged customers who have the merchant industry as one of their top ten industries by at least one of volume and expenditure;
a third variable comprising a percentage of the engaged customers who have the merchant industry as one of their top ten industries by at least one of volume and expenditure; and
a fourth variable comprising a rank of customer industry that is transacting in the merchant industry among all customer industries transacting in the merchant industry.

18. The spend engagement and relevance diagnostics host of claim 15, wherein the noise filter comprises:
a similarity score definer configured to define a base similarity score;
a math engine configured to calculate the similarity score of each of the engaged customers according to a similarity calculation;
a cull module configured to cull each of the engaged customers having the similarity score less than the base similarity score; and
a noise filter bus controlled by an iteration controller and interconnecting the similarity score definer, the math engine, and the cull module in logical communication.

19. The spend engagement and relevance diagnostics host of claim 18, wherein the similarity calculation comprises:
$$Similarity = 1 - \frac{Σ {amount}_{i} {xrank}_{i}}{Σ {amount}_{i}} / max ( {rank}_{i} ) .$$

20. A method of spend engagement and relevance diagnostics comprising:
determining, by a relevant merchant/customer industry identifier in communication with a processor, a merchant industry relevant to a known customer industry of a known customer;
identifying, by a benchmark competitor/merchant identifier in communication with the processor, a benchmark competitive customer of the known customer industry;
preparing, by a referral generator in communication with the processor, a first referral comprising a reference of the at least one of a merchant or the merchant industry to the known customer in response to the identifying; and
delivering, by a referral delivery interface in communication with the processor, the first referral to an electronic network.
